(19) United States
(12) Patent Application Publication
(10) Pub. No.: US 2020/0273618 A1
(43) Pub. Date: Aug. 27, 2020

(54) ELECTRO-MAGNETIC DEVICES AND THERMAL MANAGEMENT THEREOF

(71) Applicant: DIAMOND ELECTRIC MFG. CORP., Farmington Hills, MI (US)

(72) Inventors: BRIAN A. LIGHTHALL, BRIGHTON, MI (US); ALBERT ANTHONY SKINNER, WATERFORD, MI (US); DAVID LESTER LANGLEY, BRIGHTON, MI (US); PAUL BRYAN DEIGNAN, LAFAYETTE, IN (US)

(21) Appl. No.: 16/630,810

(22) PCT Filed: Jul. 13, 2018
(86) PCT No.: PCT/US18/42066

§ 371 Date: Jan. 13, 2020

Related U.S. Application Data
(60) Provisional application No. 62/531,937, filed on Jul. 13, 2017.

(51) Int. Cl. H01F 27/28; H01F 27/08; H01F 27/24

(52) U.S. Cl. CPC H01F 27/2895; H01F 27/24; H01F 27/08

(57) ABSTRACT

In an example, a transformer can include a core that can include a composite material and have a first permeability. The transformer can further include a primary coil that can be wound about the core. The primary coil can be configured to vary a primary magnetic energy into the core based on a primary current. The transformer can include a secondary coil that can be wound about the core. The secondary coil can be configured to establish a secondary voltage based on the primary magnetic energy. The transformer can further include an outer return that can include a laminate material and have a second permeability. The second permeability can be greater than the first permeability. The outer return can provide a magnetic-return path for magnetic energy from a first end of the core to a second end of the core.

### CROSS-REFERENCE TO RELATED APPLICATION

This application claims the benefit of U.S. Provisional Patent Application No. 62/531,937, filed Jul. 13, 2017, and entitled “ELECTRO-MAGNETIC DEVICES AND THERMAL MANAGEMENT THEREOF,” the entire contents of which is incorporated herein by reference.

### TECHNICAL FIELD

This disclosure relates to electro-magnetic devices and thermal management thereof. More particularly, this disclosure relates to ignition transformers for use in ignition systems.

### BACKGROUND

Electromagnetic devices such as ignition coils (also known as ignition transformers) are used in ignition systems to create an electrical spark and ignite a fuel-air mixture within a combustion chamber.

### SUMMARY

In an example, a transformer can include a core that can include a composite material and have a first permeability. The transformer can further include a primary coil wound about the core. The primary coil can be configured to vary a primary magnetic energy into the core based on a primary current. The transformer can include a secondary coil wound about the core. The secondary coil can be configured to establish a secondary voltage based on the primary magnetic energy. The transformer can further include an outer return that can include a laminate material and have a second permeability. The second permeability can be greater than the first permeability. The outer return can provide a magnetic-return path for magnetic energy from a first end of the core to a second end of the core.

In another example, a transformer can include a core that can include a first material and have a first permeability. The transformer can further include a primary coil that can be wound about the core. The primary coil can be configured to vary a primary magnetic energy into the core based on a primary current. The transformer can further include a secondary coil that can be wound about the core. The secondary coil can be configured to establish a secondary voltage based on the primary magnetic field. The transformer can further include an outer return that can include a second material and have a second permeability. The outer return can provide a magnetic-return path for magnetic energy from a first end of the core to a second end of the core. The transformer can further include a thermal plastic elastomer that can at least partially enclose a surface of the outer return and establish a thermal contact between the outer return and the core to provide a path for transferring heat generated by the primary coil.

In another example, a transformer can include a core that can include a first material and have a first permeability. The transformer can further include a spool that can partially surrounds the core. The transformer can further include a primary coil that can be wound about the spool to partially surround the core. The primary coil can be configured to vary a primary magnetic energy into the core. The transformer can further include a secondary coil that can be wound about the core. The secondary coil can be configured to establish a secondary voltage based on the primary magnetic energy. The transformer can further include an outer return that can include a second material and have a second permeability. The outer return can provide a magnetic-return path for magnetic energy from a first end of the core to a second end of the core.

This Summary is provided merely for purposes of summarizing some example embodiments to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

Features, objects and advantages other than those set forth above will become more readily apparent when consideration is given to the detailed description below. Such detailed description makes reference to the following drawings.

FIG. 1 illustrates an example of an ignition transformer in an exemplary ignition system.

FIG. 2 illustrates an example of a primary spool for an ignition transformer.

FIG. 3 illustrates exemplary data characterizing a linearity performance of a final product version, a prototype version and a computer simulated version of ignition transformer.

FIG. 4 illustrates an example of a B-H curve characterizing a relationship between magnetic flux density (B) and magnetic field strength (H) for a laminate core ignition transformer and a composite iron core ignition transformer.

FIG. 5 illustrates an example of an ignition transformer configured with thermal management materials.

FIG. 6 illustrates an example of an ignition transformer configured with a thermally conductive cover.

FIG. 7 illustrates an example of an ignition transformer with a thinned out return path wall.

FIG. 8 illustrates another example of an ignition transformer with a thinned out return path wall.

FIG. 9 illustrates another example of an ignition transformer in an exemplary ignition system.

### DETAILED DESCRIPTION

In general, this disclosure relates to electro-magnetic devices and thermal management thereof. Electro-magnetic devices such as ignition coils (or ignition transformers) generate excessive heat, which if not thermally managed, can lead to failures in the coil itself and/or ignition systems. In some instances, ignition coil generated heat can lead to deficiencies in reliability in the ignition coil itself and over time diminish satisfactory coil operating conditions. Another contributing factor to ignition system failure is spark plug erosion. Spark plugs are known to wear out each time the spark plug fires to create the electrical spark. A minute amount of metal is removed from the spark plugs electrode during each fire. Other causes of spark plug erosion include extended spark durations resulting from poor distribution of the fuel-air mixture.

In some examples, this disclosure describes ignition transformers for use in ignition systems for an automotive combustion engine. However, the examples described herein should not be construed and/or limited to only automotive combustion engine applications. The ignition transformers described herein can be used in any application that requires use of an ignition transformer. The ignition transformers described herein can include a core that can include a composite material and have a first permeability. The ignition transformers can further include an outer return that can include a laminate material and have a second permeability. In some examples, the composite material can correspond to a composite iron material and the laminate material can correspond to a plurality of silicon steel laminations. In an example, the first permeability can be different than the second permeability. Additionally, or alternatively, the outer return can have a greater permeability than the core. Utilizing a composite material core (e.g., a composite iron core) and a laminate outer return (e.g., a plurality of silicon steel laminations) can provide as described herein in an ignition transformer has particular advantages over conventional ignition transformers, e.g., ignition transformer that generate a non-linear secondary current waveform. The ignition transformers described herein can yield a non-linear waveform with a greater maximum coupling of a primary flux to a secondary winding in contrast to the conventional transformers. The improved ignition transformers described herein can couple peak current as high as about 90%. Conventional ignition transformers can only couple peak current as high as about 70%. Resultantly, a burn time can be extended to increase a likelihood of ignition of a mixture in a combustion chamber. Furthermore, the improved ignition transformer described herein can provide an extended spark duration while minimizing a level of spark plug erosion when compared to conventional transformers.

Additionally, or alternatively, the improved ignition transformer can be configured to exhibit improved thermal management characteristics. For example, the ignition transformer can be configured with thermally conductive materials such that transformer generated heat can be more effectively dissipated. Accordingly, the ignition transformers described herein have particular advantages over ignition transformer counterparts, which will become more readily apparent according to the examples described herein.

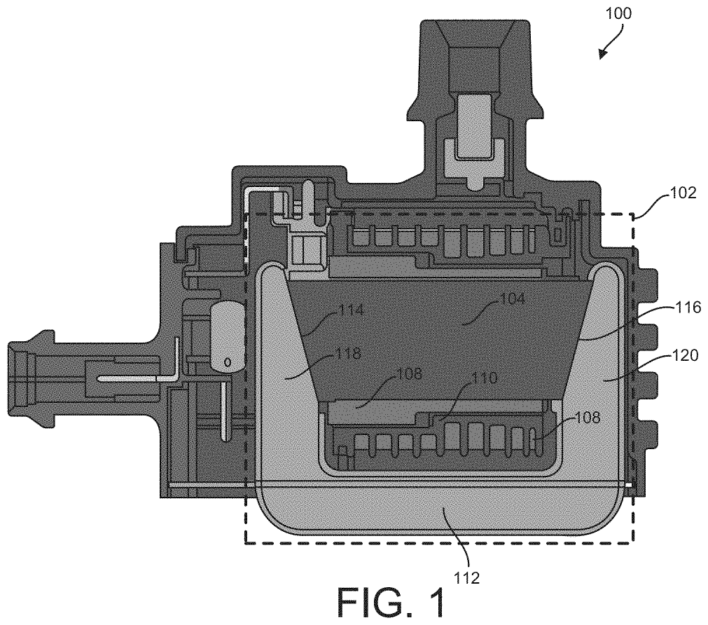

FIG. 1 illustrates an example of an ignition transformer 102 in an exemplary ignition system 100. In some examples, the exemplary ignition system 100 can correspond to a vehicle ignition system, such as employed in a vehicle, including, but not limited to, an automobile, or any vehicle that utilizes a spark based ignition system. The exemplary ignition system 100 can be coupled to a source and to one or more spark plugs (not shown in FIG. 1). In an example, the source can correspond to a battery or an electrical distribution system. The source, the one or more spark plugs, in some examples, can form part of the exemplary ignition system 100. The one or more spark plugs can be coupled to a chamber that includes a fuel-air mixture (not shown in FIG. 1). The exemplary ignition system 100 can be configured to receive electrical power from the source and provide a voltage sufficient enough to the one or more spark plugs to cause a combustion initiating spark inside the chamber.

The exemplary ignition system 100 can include an ignition transformer 102. As described herein, the ignition transformer 102 can yield a non-linear waveform with maximum coupling of a primary flux to a secondary winding. The ignition transformer 102 can include a core 104 that can include a composite material and that can have a core (or first) permeability measured in henries per meter (H/m). A composite material can correspond to a material that can include one or more constituent materials that can have different physical and/or chemical properties that, when combined, can produce a material with characteristics different from the individual components. In an example, the composite material can correspond to a composite iron material or any composite material that can have similar (or substantially similar) characteristics as the composite iron material. The composite iron material can include iron and one or more other materials (e.g., a dielectric binder). In some examples, the core 102 can have a permeability of about 50 to about 500 H/m, for example, when the core 102 includes at least iron materials.

The ignition transformer 102 can further include a primary coil 106. The primary coil 106 can be wound about the core 104. The primary coil 106 can be coupled to the source. The source can be configured to provide a primary current to the primary coil 106. In some examples, the primary current is a time-varying direct current (DC) signal or an alternating-current (AC) signal. The source can be controlled (e.g., by a controller (not shown in FIG. 1)) to provide the primary current to the primary coil 106 based on timing requirements (e.g., spark plug firing timing). The primary coil 106 can be configured to generate a primary magnetic field in response to the primary current. The primary coil 106 can be configured to establish a primary magnetic flux based on the primary magnetic field. The primary coil 106 can be configured to vary a primary magnetic energy into the core 104 based on the primary current provided by the source.

The ignition transformer 102 can further include a secondary coil 108 and a spool 110. In an example, the secondary coil 108 can be wound around the spool 110. The spool 110 can fully (or partially) enclose the core 104. In another example, the secondary coil 108 can be wound about the core 104. The primary magnetic field can induce an electromotive force (emf) in the secondary coil 108. The secondary coil 108 can be configured to generate a secondary voltage based on the primary magnetic field. The secondary coil 108 can be configured to establish the secondary voltage based on the primary magnetic energy. The one or more spark plugs can be coupled to the secondary coil 108 and configured to generate a spark discharge based on the induced secondary voltage at the secondary coil 108.

The ignition transformer 102 can further include an outer return 112. In an example, the outer return can have shape similar to a grapheme such as the letter “U”. As such, in some examples, the outer return 112 can be U-shaped. The outer return 112 can include a laminate material and can have an outer return (or second) permeability. In some examples, the outer return 112 can have a permeability that can be greater than core permeability. For example, the outer return 112 can have a permeability of about 1000 to about 20,000 H/m. In an example, the laminate material can include a plurality of silicon steel laminations or arrangement of materials that can have similar (or substantially similar) characteristics. In an example, the outer return 112 can provide a return path for the magnetic energy from the first end 114 to the second end 116 of the core 104. In some examples, the thermal conductivity of the outer return 112 can be about in a range of 23-45 watts per meter-kelvin (W/m K).

In some examples, the outer return 112 and the core 104 can be positioned relative to one another to define (or form) an air gap. The air gap can be from about 0.5 to about 2.5 millimeters (mm) wide. The air gap can be located along a magnetic circuit path containing a magneticflux of the ignition transformer 102 (e.g., the primary magnetic flux). In an example, the outer return 112 can be positioned relative to the core 104 such that respective ends 118, 120 of the outer return 112 are oriented toward their end counter-part 114,116 of the core 104. In this example, at least one of the ends 118,120 of the outer return 112 can abut a given end 114,116 of the core 104. In an alternative example, the outer return 112 and the core 104 can be positioned relative to one another such that no air gap (or substantially no air gap) exists in the magnetic circuit path, as shown in FIG. 1. Thus, both ends 118,120 of the outer return 112, in this example, can abut a corresponding end 114,116 of the core 104.

In some examples, the core 104 can include a composite iron and the outer return 112 can include a laminate material, and the primary magnetic flux can be substantially contained within the core 104. The containment of the primary magnetic flux in the core 104 can be aided by a magnetomotive force (mmf) generated by the primary coil 106. The mmf generated by the primary coil 106 is a function of the primary magnetic flux and a number of turns in the primary coil 106. In some examples, the primary coil 106 can have about 40 to about 200 turns. In these examples, a secondary to primary turn ratio of the ignition transformer 102 can be about 60 to about 200. In a particular example, the primary coil 106 can have about 66 turns and the secondary to primary turn ratio is about 175. A flux density of the ignition transformer 102 can be more consistent and greater in contrast to the conventional ignition transformer that utilizes composite iron in an outer return. The primary magnetic flux can be coupled to a secondary winding (e.g., the secondary coil 108). A greater amount of electrical energy can be transferred between the primary coil to the secondary coil in contrast to a conventional ignition transformer.

In examples wherein the ignition transformer 102 includes a composite core 104 (e.g., composite iron core) and a laminate outer return 112 (e.g., a plurality of silicon steel laminations), the ignition transformer 102 has particular advantages over conventional ignition transformers, e.g., ignition transformer that provide a non-linear secondary current waveform. For example, the ignition transformer 102 can yield a non-linear waveform with a greater maximum coupling of a primary flux to a secondary winding in contrast to the conventional transformers. The ignition transformer 102 can couple peak current as high as about 90%. Furthermore, a burn time can be extended to increase a likelihood of ignition of the mixture in a combustion chamber. Moreover, the ignition transformer 102 can provide an extended spark duration while minimizing a level of spark plug erosion when compared to conventional transformers.

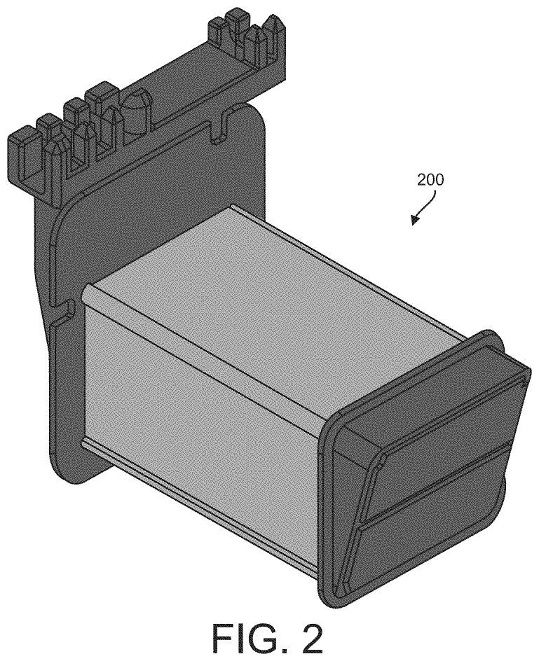

FIG. 2 illustrates an example of a primary spool 200 for an ignition transformer. In some examples, the ignition transformer is the ignition transformer 102 of FIG. 1. The ignition transformer 102 can include the primary spool 200. The primary spool 200 can be configured to at least partially surround a core of the ignition transformer. In an example, the primary spool 200 can completely surround the core. The core can be constructed to include notched corners for accepting spool ribs of the primary spool 200. In an example, wherein no air gap (or substantially no air gap) exists in the magnetic circuit path and the core is a composite iron core, a primary coil of the ignition transformer can provide the mmf to the composite iron core. The provided mmf can assist (or aid) in forcing the primary magneticflux to be bound by the composite iron core and increase the coupling of the primary flux to the secondary winding. Accordingly, the coupling of the primary flux to the secondary winding can be increased by combining the primary spool 200 with an ignition transformer. In some examples, the primary spool 200 can be configured to have no walls on its corresponding flat faces, only ribs that fit into notched corners on the core and are tolerance such that the worst case does not allow contact to the core, but minimizes the spacing between the primary winding and the core.

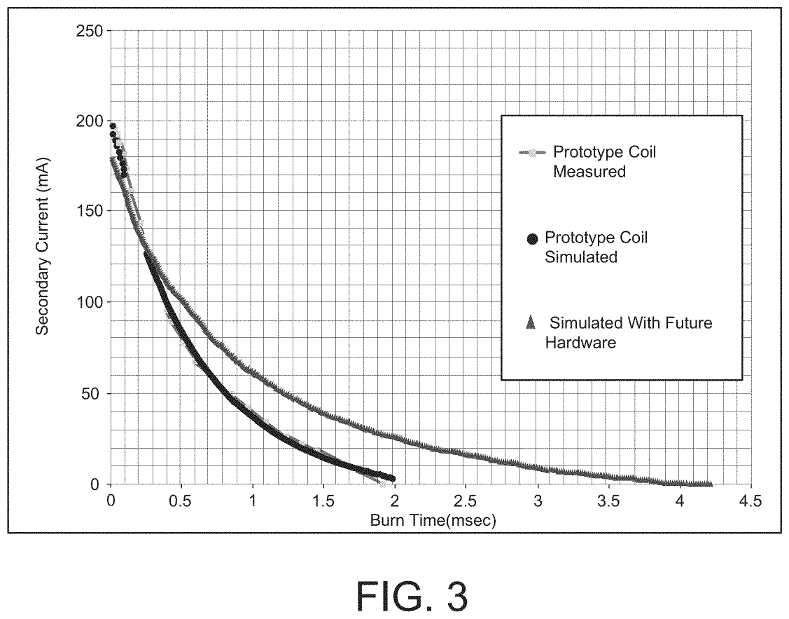

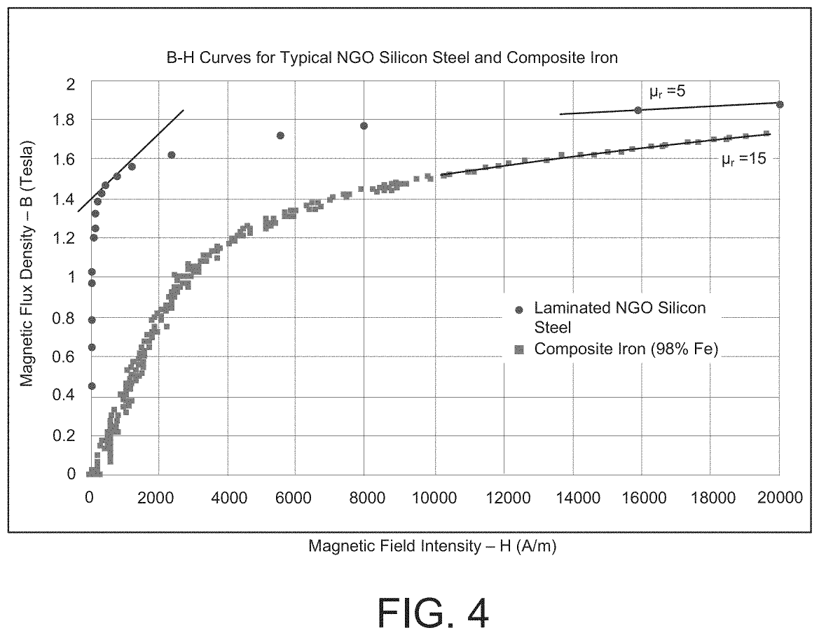

FIG. 3 illustrates exemplary data characterizing a linearity performance of a final product version, a prototype version and a computer simulated version of an ignition transformer such as the ignition transformer 102 of FIG. 1. As illustrated by the exemplary data in FIG. 3, the ignition transformer 102 of FIG. 1 has an improved non-linearity performance. The ignition transformer can have an operating point (e.g., saturating point) at which the ignition transformer obtains non-linearity that is higher in contrast to the conventional ignition transformer. A composite iron core increases the operating point of the ignition transformer since a permeability of the core (e.g., incremental permeability) is greater than in contrast to a laminate core used in the conventional ignition transformer. FIG. 4 illustrates an example of a B-H curve showing a relationship between magnetic flux density (B) and magnetic field strength (H) for a laminate core versus a composite iron core. As shown in FIG. 4, the composite iron core has a higher initial magnetic flux density as a magnetic flux intensity increases. Accordingly, the ignition transformer as described herein can have improved transformer losses (e.g., less magnetic losses) when compared to the conventional ignition transformer.

In some examples, thermal management materials can be applied to one of the ignition transformer 102, components of the exemplary ignition system 100, and a combination thereof. In an example, a thermal plastic elastomer (TPE) can be applied to the outer return 112 of the transformer 102. The TPE can include CoolPoly® D8102 by Celanese that can have a thermal conductivity of, for example, 3 W/m K. Other TPE's having similar conductive properties and characteristics can be used. As such, the examples described herein should not be construed and/or limited to only the TPE's described herein. In some examples, an all-over coating of the TPE can be applied to a surface of the outer return 112.

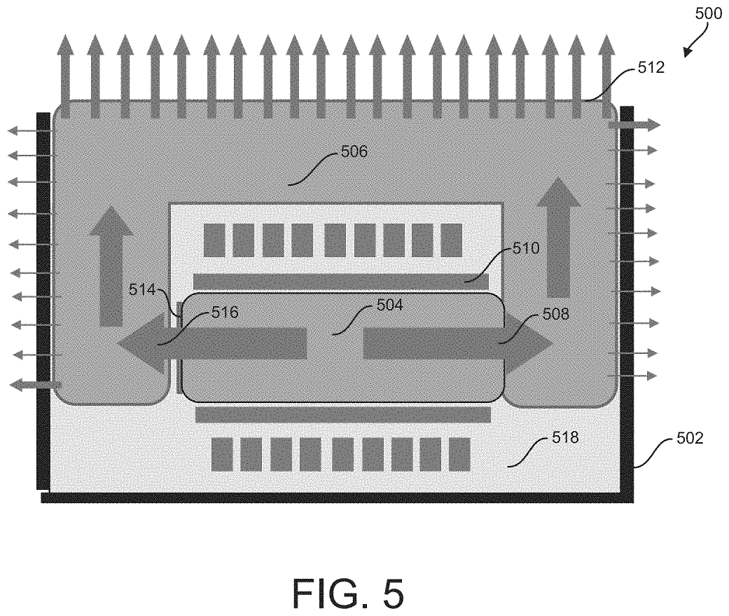

FIG. 5 illustrates an example of an ignition transformer 500 configured with thermal management materials. In some examples, the ignition transformer 500 can correspond to the ignition transformer 102, as shown in FIG. 1. The ignition transformer 500 can include a base 502. The base 502 can be configured to enclose one or more components of the transformer 500. A first end of a core 504 of the ignition transformer 500 can be in thermal contact with an end of the outer return 506 to form a first thermal path 508. Heat (illustrated as “arrows” in FIG. 5) generated by a primary coil 510 of the ignition transformer 500 can be transferred via the first thermal path 508 to the outer return 506. In some examples, as shown in FIG. 5, a top face 512 of the outer return 506 can be exposed to a surrounding environment. In this example, the outer return 506 can dissipate the heat directly into the surrounding environment. In some examples, wherein the ignition transformer 500 includes the air gap and the second end of the core 504 has been coated with the TPE, the air gap can be filled with the TPE. A TPE filled air gap 514 can function to provide a second thermal path 516 through which heat generated by the primary coil 510 can be transferred to the outer return 506 for dissipation into the surrounding environment. Thus, the second thermal path 516 provides an additional heat transfer path through which the heat generated by the primary winding 510 can be removed from the ignition transformer 500. In some examples, the ignition transformer 500 can be configured with an epoxy 518. The epoxy can have a thermal conductivity of about 0.4-0.5 W/m K.

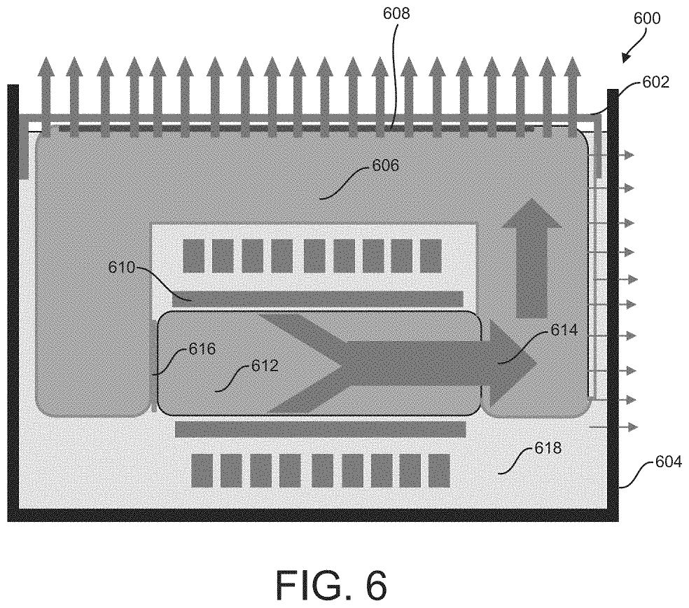

In other examples, the top face of the outer return can be covered (or protected) by a thermally conductive cover. FIG. 6 illustrates an example of an ignition transformer 600 configured with a thermally conductive cover 602. In some examples, the ignition transformer 600 can correspond to the ignition transformer 102, as shown in FIG. 1. The ignition transformer 600 can include a base 604. The base 604 can be configured to enclose one or more components of the transformer 600. A top face of an outer return 606 can be in contact with the thermally conductive cover 604 such that the heat can be dissipated into a surrounding environment. In some examples, a TPE, such as Hytrel® 55556 by DuPont™ can be applied to the top face of the outer return 606. The thermally conductive cover 602 can include a TPE material such as CoolPoly E5101 PPS by Celanese. The cover 602 can have a given thermal conductivity. In some examples, the thermally conductive cover 602 has a thermal conductivity of about 20 W/m K. The resulting total resistance at the top of the ignition transformer 600 can be about 0.000258 Kelvin meter squared per watt (K m²/W).

In some examples, a thermally conductive mating material 608 can be positioned between the thermally conductive cover 602 and the outer return 606 to eliminate (or substantially eliminate) an air gap, which results from mating the cover 602 with the outer return 606. An air gap increases a thermal resistivity between the cover 602 and the outer return 606. The thermally conductive mating material 608 fills the air gap (or substantially fills the air gap) and reduces the thermal resistivity between the cover 602 and the outer return 606. The thermally conductive mating material 608 can include one of a glue, an epoxy, a paste and a tape, such as an 8805 series adhesive transfer tape by 3M™. The thermally conductive mating material 608 can have a thickness. In some examples, the thickness is 0.125 mm with a thermal conductivity of about 0.6 W/m K. The resulting total resistance at the top of the ignition transformer 600 can be about 0.004208 K m²/W.

In some examples, a first end of a core 612 of the ignition transformer 600 can be in thermal contact with an end of the outer return 606 to define a first thermal path 614. A primary coil 610 of the ignition transformer 600 can generate heat (shown as “arrows” in FIG. 6). Heat (illustrated as “arrows” in FIG. 6) generated by the primary coil 610 can be transferred via the first thermal path 614 to the outer return 606. The outer return 606 can be coupled to the thermally conductive material 606 and transfer the heat further to the thermally conductive cover 602, which can dissipate the heat into the surrounding environment. In an example, the outer return 606 and the core 612 can be positioned relative to one another to define (or form) an air gap 616. The air gap 616 can be located along a magnetic circuit path containing a magnetic flux of the ignition transformer 600 (e.g., the primary magnetic flux). The ignition transformer 600 can be configured with an epoxy 618. The epoxy can have a thermal conductivity of about 0.4-0.5 W/m K.

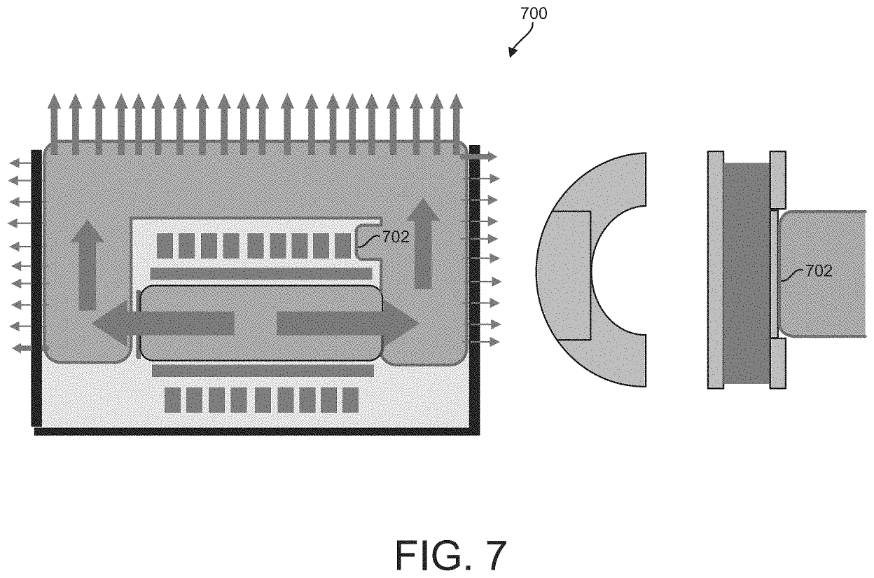

In an even further example, a segment of a wall in an area of the laminate outer return path can be thinned out. FIG. 7 illustrates an example of an ignition transformer 700 with a thermally coated thinned out return path wall 702. In some examples, the ignition transformer 700 can correspond to one of the ignition transformer 102, as shown in FIG. 1, and the ignition transformer 500, as shown in FIG. 5. The ignition transformer 700 can be used in applications that require high secondary currents and/or require a long burn time. The segment of the wall in the area of the outer return path can be thinned about, for example, from about 0.3 to about 0.5 mm. In an example, the thinned out return path wall 702 can be coated with a TPE, such as the Cool Poly® D8102 by Celanese. The thinned out return path wall 702 can minimize a thermal resistance from a secondary winding of the transformer 700. Minimizing the thermal resistance from the secondary winding limits excessive resistive losses in the ignition transformer 700. Accordingly, thinning out a segment of the outer return that interfaces with the secondary coil decreases the thermal resistance between the secondary windings and the outer return by providing the ignition transformer 700 with a thermal path for dissipating heat generated by the secondary winding.

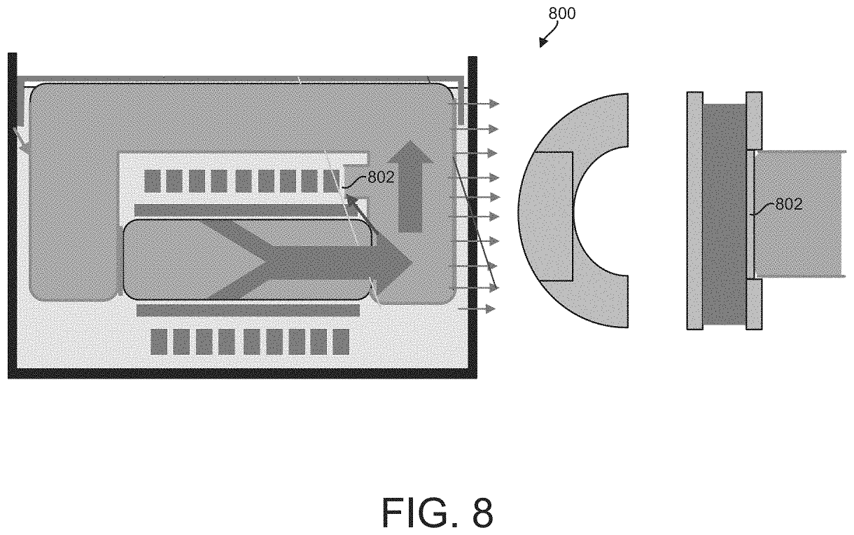

In another example, the thinned out return path wall could be bare (e.g., not coated). FIG. 8 illustrates an example of a transformer 800 with a non-thermally coated thinned out return path wall 802. In some examples, the ignition transformer 800 can correspond to one of the ignition transformer 102, as shown in FIG. 1, and the ignition transformer 600, as shown in FIG. 6. A bare thinned out return path wall 802 can minimize a thermal resistance from a secondary winding to the outer return in the ignition transformer 800. Thus, thinning out a segment of the outer return that interfaces with the secondary coil decreases the thermal resistance between the secondary windings and the outer return by providing the ignition transformer 800 with a thermal path for dissipating heat generated by the secondary winding.

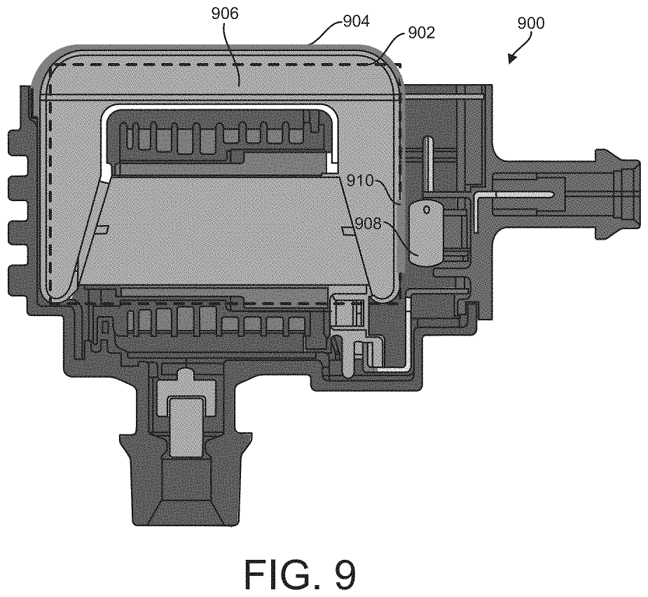

FIG. 9 illustrates another example of an ignition transformer 902 in an exemplary ignition system 900. In some examples, the ignition transformer 902 can correspond to one of the ignition transformer 102, as shown in FIG. 1, the ignition transformer 500, as shown in FIG. 5, and the ignition transformer 700, as shown in FIG. 7. The exemplary ignition system 900 can include a thermally conductive cover 904 that can be configured to surround one or more components of the exemplary ignition system 900. For example, thermally conductive cover 904 can be configured to at least partially surround the ignition transformer 902 (e.g., a primary coil, a secondary coil, a laminate outer return, a primary spool, a secondary spool, or a combination thereof). In some examples, the thermally conductive cover 904 can be fabricated of thermally conductive materials, as described herein. A top face of the outer return 906 can be covered (or protected) by the thermally conductive cover 904. The top face of the outer return 906 can be in contact with the thermally conductive cover 904 such that the heat can be dissipated into the surrounding environment.

The exemplary ignition system 900 can further include an ignitor 908. The exemplary ignition system 900 can further include a raised pad 910 with a lead in an angle that presses against the ignitor 906. The raised paid 910 can be positioned between the ignitor 906 and the thermally conductive cover 904, as shown in FIG. 9. The raised pad 910 can be configured to abut against at least a portion of a side of the thermally conductive cover 904 and at least a portion of the ignitor 906. Ignitor generated heat can be transferred via the raised pad 910 from the ignitor 906 to the thermally conductive cover 904, which can dissipate the heat into the surrounding environment.

What have been described above are examples. It is, of course, not possible to describe every conceivable combination of components for purposes of describing the examples of the disclosure described herein, but one of ordinary skill in the art will recognize that many further combinations and permutations of the examples are possible. Accordingly, the examples described herein are intended to embrace all such alterations, modifications and variations that fall within the scope of the appended claims and the application. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A transformer comprising:
a core comprising a composite material and having a first permeability;
a primary coil wound about the core, the primary coil being configured to vary a primary magnetic energy into the core based on a primary current;
a secondary coil wound about the core, the secondary coil be configured to establish a secondary voltage based on the primary magnetic energy; and
an outer return comprising a laminate material and having a second permeability that is greater than the first permeability, wherein the outer return provides a magnetic-return path for magnetic energy from a first end of the core to a second end of the core.

2. The transformer of claim 1, wherein the outer return and the core are positioned relative to one another such that no air gap exists along a magnetic circuit path containing a magnetic flux generated by the primary coil.

3. The transformer of claim 2, further comprising a thermal plastic elastomer (TPE) enclosing a surface of the outer return to establish a thermal contact between the outer return and the core to provide a path for transferring heat generated by the primary coil to a surrounding environment.

4. The transformer of claim 1, wherein the first permeability is about 50 to about 500 henries per meter (H/m).

5. The transformer of claim 1, wherein the second permeability is about 1000 to about 20,000 henries per meter (H/m).

6. The transformer of claim 1, wherein the laminate material comprises a plurality of silicon steel laminations and the composite material comprises iron.

7. The transformer of claim 1, further comprising a spool configured to partially surround the core.

8. The transformer of claim 6, wherein the primary coil is wound about the spool to partially surrounds the core.

9. A transformer comprising:
a core comprising a first material and having a first permeability;
a primary coil wound about the core, the primary coil being configured to vary a primary magnetic energy into the core based on a primary current;
a secondary coil wound about the core, the secondary coil be configured to establish a secondary voltage based on the primary magnetic field;
an outer return comprising a second material and having a second permeability, the outer return providing a magnetic-return path for magnetic energy from a first end of the core to a second end of the core; and
a thermal plastic elastomer that at least partially encloses a surface of the outer return and establishes a thermal contact between the outer return and the core to provide a path for transferring heat generated by the primary coil.

10. The transformer of claim 9,
wherein the first end of the core is in thermal contact with a given end of the outer return to provide a first thermal path, and wherein the second end of the core is in thermal contact with another end of the outer return that is distal to a given end of the outer return to provide a second thermal path; and
wherein the first and the second thermal paths transfer the heat generated by the primary coil to a surrounding environment.

11. The transformer of claim 9, wherein the first material comprises iron.

12. The transformer of claim 9, wherein the second material comprises a plurality of silicon steel laminations.

13. The transformer of claim 9, wherein the outer return comprises a thinned-out contact area, the thinned-out contact area reducing a thermal resistance between the secondary coil and the outer return.

14. The transformer of claim 9, further comprising a thermally conductive plastic cover positioned over a portion of the surface of the outer return to establish a heat transfer path.

15. The transformer of claim 14, further comprising a thermally conductive mating material disposed between the thermally conductive plastic cover and the portion of the surface of the outer return.

16. The transformer of claim 15, wherein the thermally conductive mating material is configured to receive the heat generated by the primary coil from the portion of the surface of the outer return and transfer the heat to the thermally conductive plastic cover for dissipation into a surrounding environment.

17. The transformer of claim 14, wherein the thermally conductive plastic cover is coupled to one or more devices.

18. The transformer of claim 17, wherein the thermally conductive plastic cover is configured to dissipate the heat generated by the one or more devices into a surrounding environment.

19. A transformer comprising:
a core comprising a first material and having a first permeability;
a spool that partially surrounds the core;
a primary coil wound about the spool partially surround the core, the primary coil being configured to vary a primary magnetic energy into the core;
a secondary coil wound about the core, the secondary coil be configured to establish a secondary voltage based on the primary magnetic energy; and
an outer return comprising a second material and having a second permeability, the outer return providing a magnetic-return path for magnetic energy from a first end of the core to a second end of the core.

20. The transformer of claim 19, wherein the first material comprises iron and the second material comprises a plurality of silicon steel laminations.
